(19) United States
(12) Patent Application Publication
(10) Pub. No.: US 2007/0209705 A1
(43) Pub. Date: Sep. 13, 2007

(54) Drain valve

(76) Inventors: Randall W. Nichols, Westlake, OH (US); Gregory R. Ashley, Amherst, OH (US); Leonard A. Quinn, Lagrange, OH (US); Fred W. Hoffman, Columbia Station, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/370,477

(22) Filed: Mar. 7, 2006

(51) Int. Cl. F16T 1/14

(52) U.S. Cl. 137/204

(57) ABSTRACT

A drain valve for a vehicle compressed air system. The drain valve including a body portion is adapted to separate water, debris and other relatively heavy objects from a compressed air stream passing through the valve and a gladhand portion capable of connecting to a gladhand connector. The drain may also include a pressure actuated valve and drain port for automatically discharging water from the drain valve.

### BACKGROUND

Towed vehicles, such as for example tractor-truck trailers, container chassis, dollies or rail cars, are designed to be connected and disconnected. The air brakes on these towed vehicles are powered and controlled from the tractor through two pneumatic lines—one line supplies air at full system pressure to power the trailer brakes, and the other supplies a pneumatic control signal of varying pressure to indicate when the brakes should be applied or released. The standard connection for these lines between the tractor and trailer is called a gladhand. When the trailer is disconnected from the tractor, the gladhands are generally exposed to the environment, and thus allow water, debris and insects into the system. Water and debris in the system can impact the brake control valves and may even cause them to malfunction.

Known approaches to addressing this concern include: providing the open gladhand with the ability to rotate against a seal to close the opening; providing a flapper door that closes over the gladhand opening when the gladhand is disconnected; and placing a screen in-line to catch debris that enters the air lines. For a variety of reasons, such as degrading seal integrity and screen blockage, these solutions can be less effective than desired.

U.S. patent application Ser. No. 10/926,251, the entire disclosure of which is hereby incorporated by reference, discloses a mechanism which can effectively capture and vent water and debris that is introduced into the trailer air brake system while the gladhands are uncoupled. This mechanism is often mounted at a low-point in the air brake system, such as the underside of the trailer on a cross-member. This location, however, makes mounting, inspecting, and servicing the mechanism difficult and awkward.

### SUMMARY

The present application relates to a drain valve for a vehicle compressed air system. In particular the present application relates to a drain valve having a body portion adapted to separate water, debris and other relatively heavy objects from a compressed air stream and a gladhand portion capable of connecting to a gladhand connector. In one embodiment, the gladhand portion and body portion are formed as a single, integrated part. The drain valve may include a pressure actuated valve and drain port for automatically discharging water from the drain valve.

### DRAWING DESCRIPTIONS

In the accompanying drawings, which are incorporated in and constitute a part of this specification, embodiments of the invention are illustrated, which, together with a general description of the invention given above, and the detailed description given below serve to illustrate the principles of this invention.

FIG. 1 is a schematic representation of a vehicle air brake system utilizing an exemplary embodiment of a drain valve according to the present invention, shown enlarged in the area of a gladhand connection;

FIG. 2 is a first perspective view of an exemplary embodiment of the drain valve according to the present invention;

FIG. 3 is a second perspective view of an exemplary embodiment of the drain valve of FIG. 2;

FIG. 4 is a longitudinal cross section of an exemplary embodiment of the drain valve of FIG. 2;

FIG. 5 is a horizontal cross section of an exemplary embodiment of the drain valve of FIG. 2;

FIG. 6 is the perspective view of an exemplary embodiment of the drain valve of FIG. 2 shown mounted in a bulkhead mounting style;

FIG. 7 is a perspective view of another exemplary embodiment of a drain valve according to the present invention, shown mounted onto an L-bracket;

FIG. 8 is a first perspective view of another exemplary embodiment of a drain valve; according to the present invention;

FIG. 9 is a second perspective view of an exemplary embodiment of the drain valve of FIG. 8;

FIG. 10 is a perspective view of another embodiment of a drain valve according to the present invention;

FIG. 11 is a perspective view of another embodiment of a drain valve according to the present invention, showing two valves mounted to a towed vehicle;

FIG. 12 is a longitudinal cross-sectional view of exemplary embodiment of the drain valve of FIG. 11; and

FIG. 13 is a perspective view of a mounting arrangement of another exemplary embodiment of a drain valve according to the present invention.

### DETAILED DESCRIPTION

While various aspects and concepts of the invention are described and illustrated herein as embodied in combination in the exemplary embodiments, these various aspects and concepts may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or identified herein as conventional or standard or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

The present invention is directed to a drain valve 10 that combines, in a single assembly or integrated part, a gladhand style connection and a mechanism capable of separating water and/or debris from a compressed air stream. Gladhand connectors are known in the art as the standard pneumatic connector style used to connect the pneumatic lines of a towed vehicle and the pneumatic lines of a towing vehicle, such as for example a trailer, a dolly, or a container chassis. An example of a gladhand connector is disclosed in U.S. Pat. No. 3,241,865, the entire disclosure of which is incorporated by reference herein.

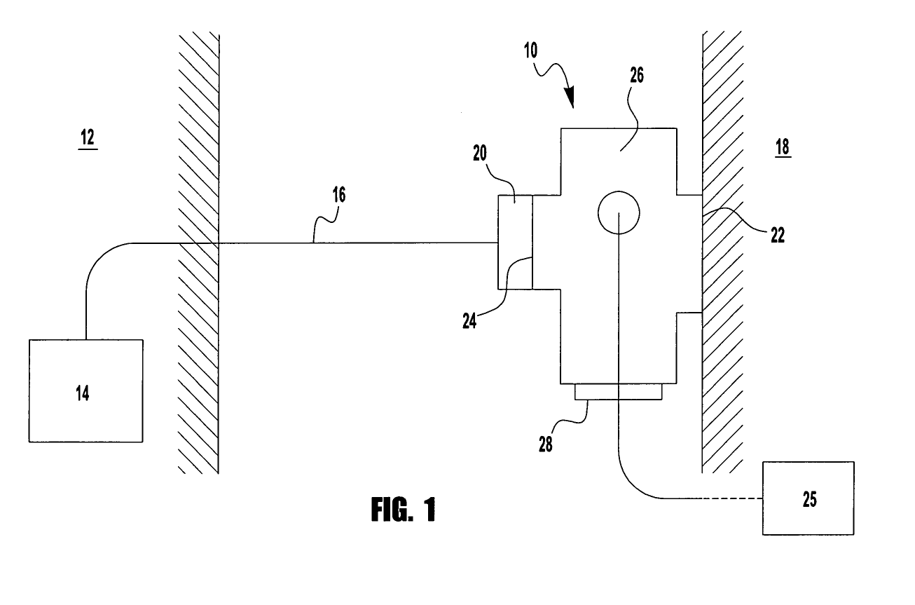

FIG. 1 illustrates a schematic representation of an example of a compressed air brake system utilizing an exemplary embodiment of a drain valve 10. Generally, a towing vehicle 12, such as for example a tractor truck, includes a pressurized air source 14. An air line 16 from the pressurized air source 14 extends from the towing vehicle 12 toward a towed vehicle 18, and terminates in a gladhand connector 20.

The drain valve 10 mounts via a mounting portion 22 onto the towed vehicle 18 at a location accessible to the gladhand connector 20 of the towing vehicle 12. The drain valve 10 includes a gladhand connector portion 24 adapted to couple to the gladhand connector 20 to allow a compressed air stream from the pressurized air source 14 to flow through the drain valve 10 and be delivered to the towed vehicle brake components, such as for example, a brake valve, generally referenced as 25. The drain valve 10 includes a body portion 26 adapted to separate heavier material, such as water and debris, from the air stream. The separated water and debris may be automatically discharged from the drain valve 10 via a drain port 28.

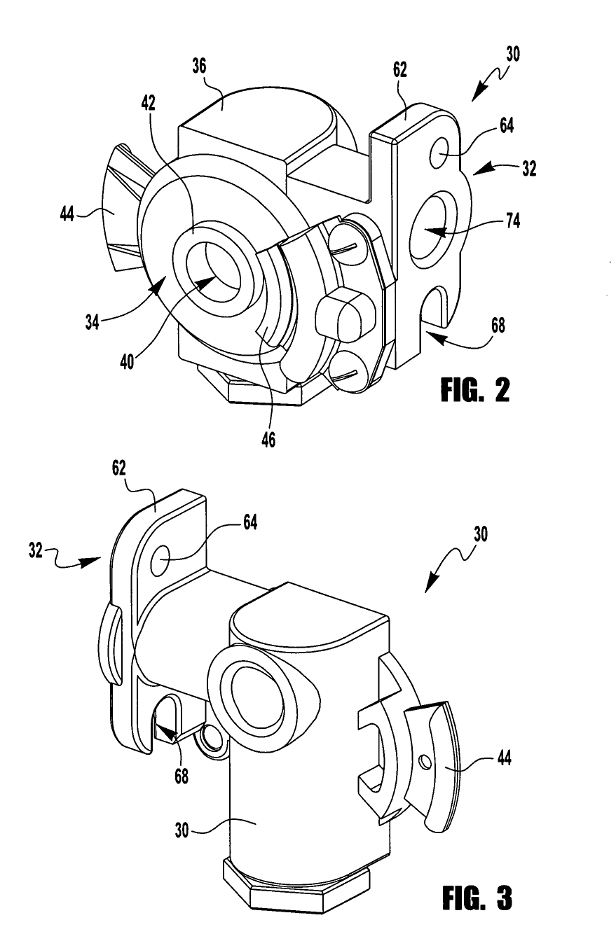

FIGS. 2 and 3 illustrate two perspective views of an exemplary embodiment of the drain valve 30 according to the present invention. In this embodiment, the drain valve 30 includes a mounting portion 32, a gladhand portion 34, and a body portion 36. The body portion 36 and the gladhand portion 34 may be formed as a single, integrated part, as shown in FIGS. 1 and 2, or they may be an assembly in which the body portion attaches directly to or adjacent to the gladhand portion, as shown in, for example, the drain valve of FIG. 11 and discussed hereinafter.

The gladhand portion 34 of the drain valve 30 is configured to couple with a gladhand connector. As such, the gladhand portion 34 may include an inlet opening 40, a seal 42 adjacent the inlet opening 40, a tab 44, and a tab receiving portion 46. The tab 44 and the tab receiving portion 46 are configured to engage a tab receiving portion and tab on a corresponding gladhand connector, respectively.

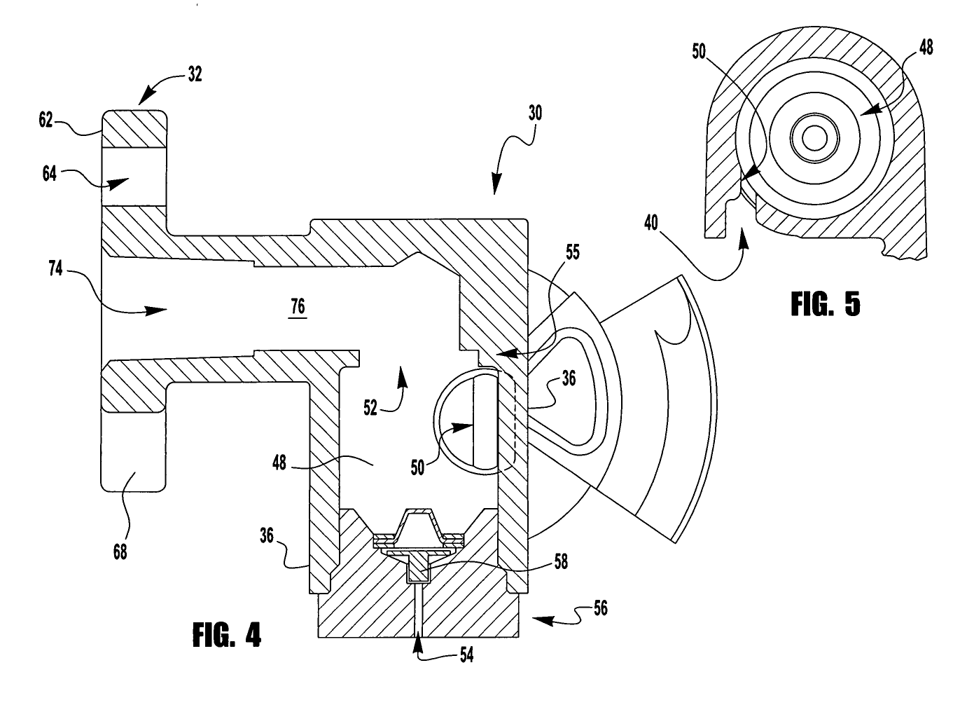

Referring to FIG. 4, the body portion 36 may include a sump 48, a sump inlet 50, a sump outlet 52, and a drain port 54 located along a base portion 55 of the body portion 36. The function and configuration of the drain valve is substantially similar to the drain valve disclosed in U.S. patent application Ser. No. 10/926,251, the entire disclosure of which is hereby incorporated by reference. Therefore, a detailed description of the function and design of the drain valve 30 will not be presented beyond sufficient detail to generally explain the valve's function.

The inlet opening 40 in the gladhand portion 34 communicates with the sump inlet 50, which is positioned such that an inlet stream of compressed air enters the sump 48 tangentially thereby creating a vortex within the sump 48 which separates the inlet stream by weight. The sump outlet 52 is positioned at a top portion 56 of the body portion 36. The outlet 52 receives a contaminant reduced portion of the inlet air stream for distribution to downstream brake components 25. Additionally, the body portion 36 may include a pressure actuated valve 58 that is used to close the drain port 54 when pressure is applied to the system and to open the drain port 54 to allow exhaust of the water and debris when there is little to no pressure in the drain valve 30. Since the pressure actuated valve 58 is actuated by pressure swings within the sump 48 that result from the normal operation of the compressed air lines, the drain port 54 is automatically accessed to discharge the collected material.

As shown in FIG. 4, the sump inlet 50 may be configured as a vertical slot, however, other configurations are also possible, such as, for example, a generally circular opening. A vertical slot configuration for the sump inlet 50 may enhance the vortex and separation action as compared to a circular opening.

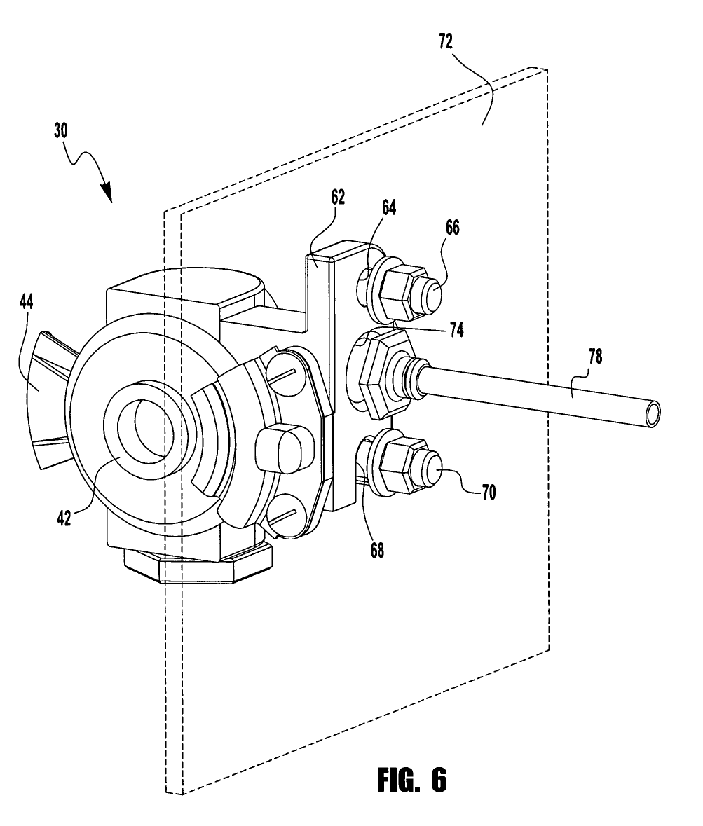

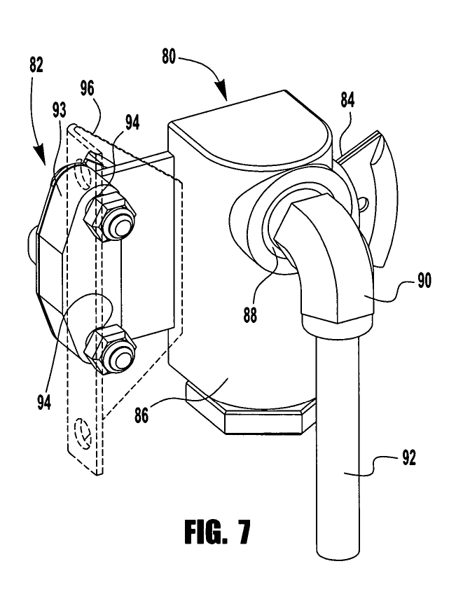

The mounting portion 32 of the drain valve 30 can be configured in a variety of ways, examples of which are illustrated in the exemplary embodiments herein. Referring to FIG. 6 (and also FIGS. 2-5), the mounting portion 32 includes an integrally formed bracket 62. The bracket 62 includes an upper opening 64 for receiving a first fastener 66 and a lower opening 68 for receiving a second fastener 70. The fasteners 66, 70 may be used to mount the drain valve 30 to the nose of a towed vehicle 72 or other suitable location. Other means of attaching the drain valve 30 to the towed vehicle 72, however, may be used.

The drain valve 30 includes a delivery port 74 in communication with the sump outlet 52 via a passage 76 (see FIG. 4). The delivery port 74 may be positioned at the mounting portion 32 for a bulkhead style mounting configuration as shown in FIG. 6. A pneumatic air line (not shown) may attach to the delivery port 74, as is known in the art, to allow the air stream exiting the drain valve 30 to be delivered to the downstream components 25. The drain valve 30, however, may be configured to position the delivery port 74 in a variety of locations.

The drain valve 30 may be formed from a variety of processes and from a variety of material. In the exemplary embodiment of FIGS. 2-6 and 10-12, die-cast plastic or aluminum or extruded aluminum has been found to be acceptable. Other materials and processes, however, can be employed.

FIG. 7 illustrates another embodiment of the drain valve according to the present invention. In this embodiment, the drain valve 80 has a similar basic design and similar features as were described above for the drain valve 30 of FIGS. 2-6. Namely, the drain valve 80 includes a mounting portion 82, a gladhand portion 84, and a body portion 86, formed as a single, integrated part.

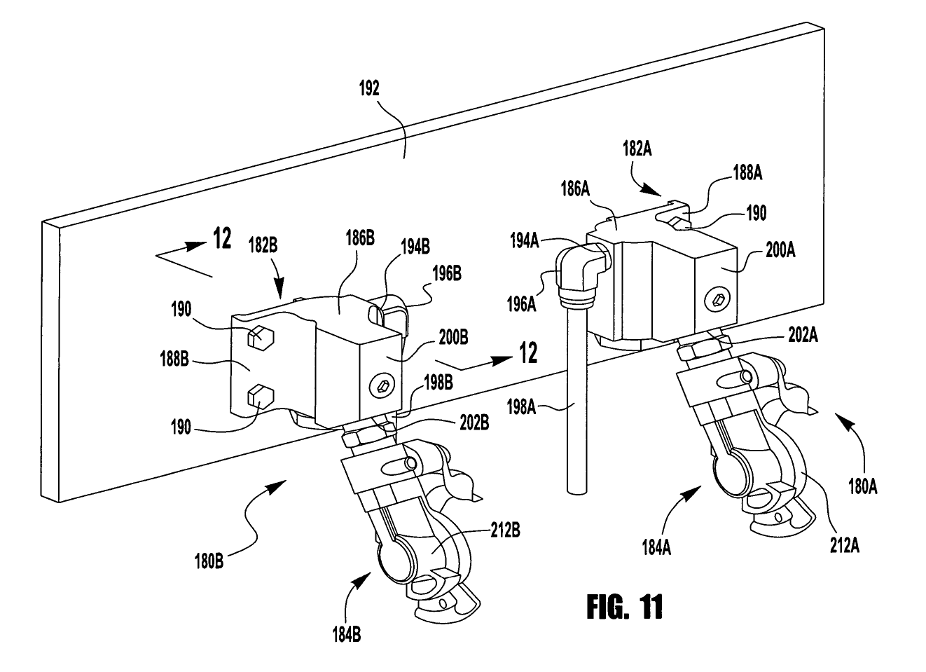

In this example, however, a delivery port 88 is located on the side of the body portion 86. The side location of the delivery port 88, as compared to a top delivery as shown in FIG. 10, provides a more convenient location for directing the exiting air flow downward, which is the typical direction that pneumatic lines are arranged on a towed vehicle such as a truck trailer. The air flow may be directed downward, for example, by attaching an elbow fitting 90 and a downward directed pneumatic line 92 to the delivery port 88. Alternatively, other approaches may be used to achieve a downward directed airflow, such as for example, casting or machining a downward facing port in the body portion.

FIG. 7 also illustrates another example of a mounting configuration for the drain valve 80. The mounting portion 82 includes a flange 93 having one or more fastener openings 94 for mounting the drain valve 80 to an L-shaped bracket 96. The L-shaped bracket 96 would, in turn, mount to a towed vehicle (not shown), by fasteners for example.

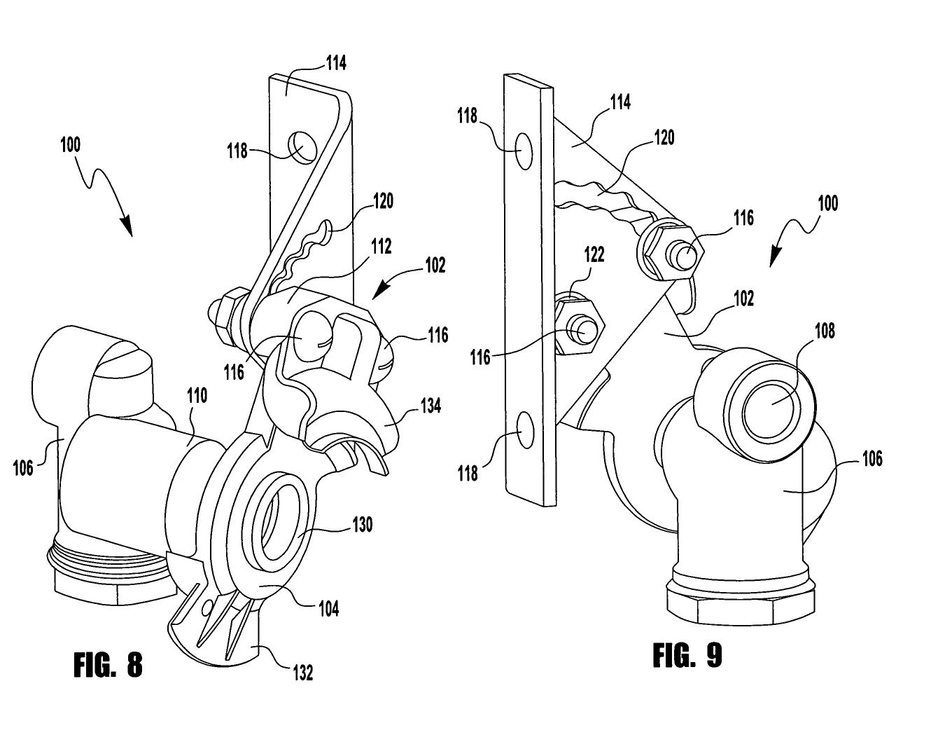

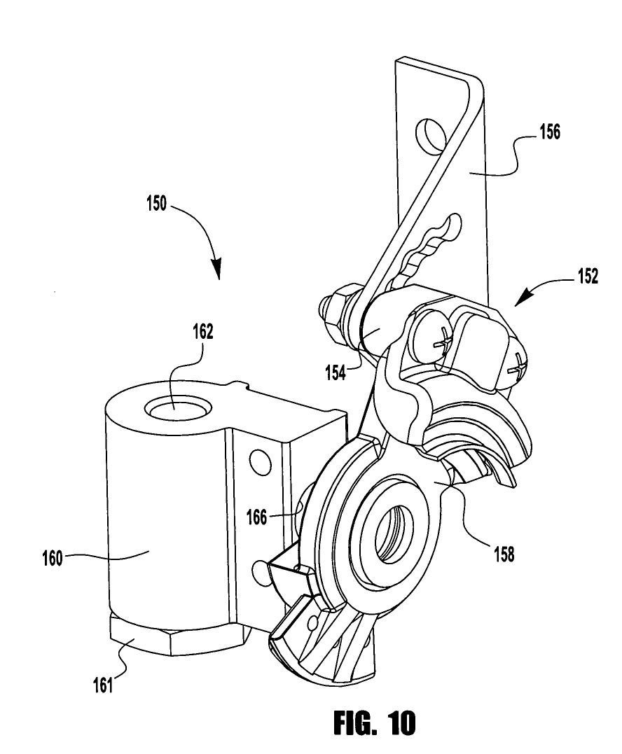

FIGS. 8-9 illustrate a first and a second perspective view of another exemplary embodiment of the drain valve according to the present invention. The drain valve 100 has a similar basic design and similar features as were described above for the drain valve 30 of FIGS. 2-6. In this embodiment, the drain valve 100 includes a mounting portion 102, a gladhand portion 104, and a body portion 106. The body portion 106 has a side-facing delivery port 108 similar to the delivery port 88 of FIG. 7. An intermediate portion 110 connects the body portion 106 with the gladhand portion 104.

The gladhand portion 104 includes a seal 130, a tab 132, and a tab receiving portion 134. As compared to the drain valve 30 in FIGS. 2-6, in which the tab 44 and tab receiving 46 are generally positioned along the same horizontal plane, in this embodiment the tab 132 is positioned lower than the tab receiving portion 134. As a result, when a typical gladhand connector couples with the gladhand portion 104 the flow path of air into the drain valve 100 is angled upward, which aids in reducing the amount of water that may enter the valve 100.

In addition, the higher position of the tab receiving portion 134 allows for gradual disengagement and reduces the amount of horizontal force required to break the gladhand connection should an operator inadvertently move the towing vehicle away from the towed vehicle while the gladhands are still attached. When a greater force is required to break the connection between the gladhands, the likelihood that a gladhand will violently collide with the back of the towing vehicle after the connection is broken is greater. In addition, this configuration permits ease of coupling the gladhands to the trailer.

The mounting portion 102 is configured similar to the mounting portion 82 in the drain valve 80 of FIG. 7 in that it includes a flange 112 which may mount to an L-shaped bracket 114 by one or more fasteners 116 or other suitable means. The bracket 114 may include one or more fastener openings 118 to facilitate mounting the bracket 114 onto a towed vehicle (not shown). In the exemplary embodiment in FIGS. 8-9, the bracket 114 includes an upper opening or slot 120 for receiving one of the fasteners 116 for adjustably mounting the drain valve 100 to the bracket 114 and a lower opening 122 for receiving another fastener 116.

When the fastener 116 that is received in the upper opening 120 is tightened down, the drain valve 100 is held securely in place. However, when the fastener is loosened, the drain valve 100 may pivot about the fastener that is received in lower opening 122. The adjustable mounting allows the gladhand portion 104 to be positioned to allow varied gladhand angle relative to the mounting surface of the towed vehicle while maintaining an operative position for the drain valve. In addition, it is more convenient for attaching a gladhand connector to it.

FIG. 10 illustrates a perspective view of another exemplary embodiment of the drain valve according to the present invention. The drain valve 150 has a similar basic design and similar features as were described above for the drain valve 100 of FIGS. 8-9. In particular, the drain valve 150 includes a mounting portion 152 having a flange 154 and a bracket 156, a gladhand portion 158 integrally formed with the flange 154, and a body portion 160.

In this embodiment, however, the body portion 160 includes a drain valve as disclosed in U.S. patent application Ser. No. 10/926,251. The body portion 160 includes a delivery port 162 positioned such that the air stream exits the top of the drain valve 150. The body portion 160 also includes an inlet port 166. In this exemplary embodiment, the glad hand portion 158 and the body portion 160 are not formed as a single integrated part, though such a configuration is possible, Instead, an attachment means is used to attach the gladhand portion 158 to the body portion 160. For example, the inlet port 166 may include female threads and the gladhand portion 158 may include a male threaded extension that can threadably engage the female threaded inlet port 166 of the body portion 160. Other methods and modes of attachment are also possible.

FIG. 11 illustrates another exemplary embodiment of a drain valve according to the present invention. Two drain valves 180A, 180B are illustrated in FIG. 11. Both valves 180A, 180B have the same features and design with the exception that one valve is configured as a right mounted valve 180A and the other valve is configured as a left mounted valve 180B. Each valve 180A, 180B, however, need not necessarily be mounted according to its right or left mounting configuration, this is for convenience.

The drain valves 180A, 180B have a similar basic design and similar features as were described above for the drain valve 30 of FIGS. 2-6. In particular, the drain valves 180A, 180B include a mounting portion 182A, 182B, a glad hand portion 184A, 184B and a body portion 186A, 186B. The mounting portion 182A, 182B includes an integrally formed flange 188A, 188B. Fasteners 190 may be used in conjunction with the flange 188A, 188B to mount the drain valve 180A, 180B to a towed vehicle 192.

The body portion 186A, 186B includes a side delivery port 194A, 194B that may be used to direct an air stream exiting the drain valve 180A, 180B downward, similar to the drain valve 100 in FIG. 8-9. This may be accomplished, for example, by using an elbow 196A, 196B and an air line 198A, 198B.

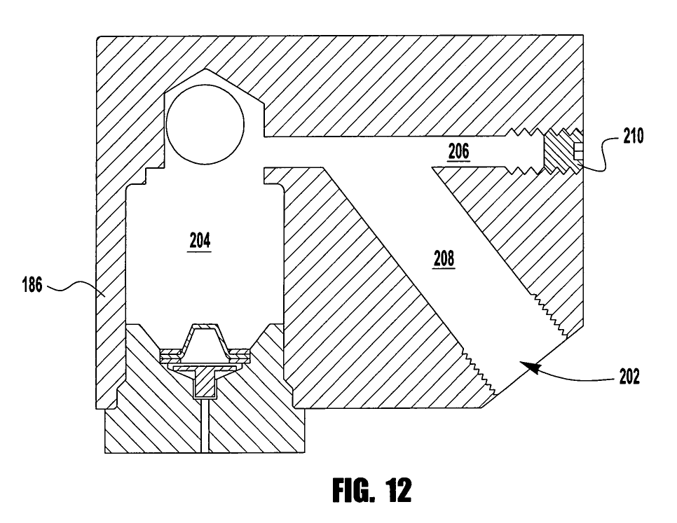

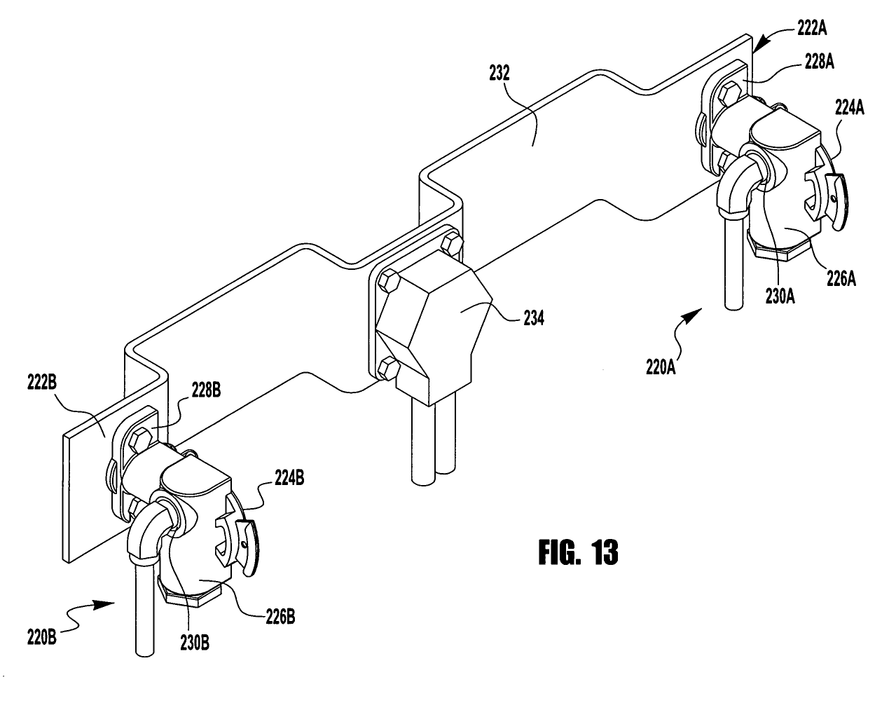

The body portion 186A, 186B includes an intermediate portion 200A, 200B, which includes sufficient material to allow an inlet opening 202A, 202B to be formed therein, such as for example, by drilling and tapping an NPT port. In the example in FIG. 11, the inlet opening 202A, 202B is shown angled downward, such as for example, at around 45 degrees to 60 degrees from the horizontal. As shown in FIG. 12, the inlet opening 202 is internally connected to a sump 204 in the body portion 186. This may be accomplished by drilling a horizontal passage 206 through the body portion 186 to the sump 204. An angled passage 208 including the angled inlet opening 202, may be drilled to intersect the horizontal passage 206. A plug 210 can be inserted into the horizontal passage 206 to prevent air leakage.

The gladhand portion 184A, 184B includes a gladhand connector 212A, 212B, which may be a conventional style gladhand connector. Thus, the gladhand connector 212A, 212B is not integrally formed with the body portion 186A, 186B. Instead, the gladhand portion 184A, 184B is attached, either directly or adjacent to, the body portion 186A, 186B. In the example of FIG. 11, an attachment means, such as for example, a fitting, is used to threadably connect the gladhand portion 184A, 184B to the inlet opening 202. The gladhand portion and inlet portion, however, can attach in other suitable ways.

The configuration of the drain valve 180 with a gladhand portion 184 attached to a downward angled inlet opening 202 provides the drain valve 180 with an upward sloping flow direction for air entering the sump 204. This helps reduce the likelihood and amount of water and/or debris entering the drain valve 180.

FIG. 13 illustrates an example of a mounting assembly for the drain valve according to the present invention. In FIG. 13, two drain valves 220A, 220B are illustrated. The drain valves 220A, 220B have a similar basic design and similar features as were described above for the drain valve 30 of FIGS. 2-4. In particular, the drain valves 220A, 220B include a mounting portion 222A, 222B, a gladhand portion 224A, 224B, and a body portion 226A, 226B formed as a single, integrated part. In the example illustrated in FIG. 12, the mounting portion 222A, 222B includes a flange 228A, 228B for mounting the drain valve 220A, 220B similar to the flange 32 of the drain valve 30, as shown in FIG. 2. Unlike the drain valve 30, however, in this embodiment, the drain valve 220A, 220B includes a side delivery opening 230A, 230B similar to the opening 88 of drain valve 80 of FIG. 7.

In the mounting configuration in FIG. 13, the two drain valves 220A, 220B are mounted onto a bracket 232. In addition, an electrical connector 234 for a towed vehicle (not shown) is also mounted onto the bracket 232. The bracket 232 can be mounted, as a module, onto a towed vehicle, thus providing a single unit that would make installation simpler and less expensive.

The invention has been described with reference to the preferred embodiments. Modification and alterations will occur to others upon a reading and understanding of this specification. It is intended to include all such modifications and alterations insofar as they come within the scope of the appended claims or the equivalents thereof.

1. A drain valve for use on a towed vehicle, comprising:
a body portion including a sump, the sump having an air inlet and an air outlet;
a gladhand portion adjacent the body portion and capable of connecting to a gladhand connector, the gladhand portion having an air passage in fluid communication with the sump air inlet,
wherein the drain valve is capable of separating liquid from an air stream that flows through the sump.

2. The drain valve according to claim 1 wherein the gladhand portion and the body portion are integrated into a single part.

3. The drain valve according to claim 1 wherein the air inlet is positioned such that the air stream enters the sump tangentially thereby creating a vortex which reduces contaminants in the air stream, and wherein the air outlet is positioned at a top portion of the drain valve and receives a contaminant reduced portion of the air stream for distribution to downstream components.

4. The drain valve according to claim 1 wherein the air inlet is configured as a vertical slot.

5. The drain valve according to claim 4 wherein the vertical slot is tangential to the sump.

6. The drain valve according to claim 1 further comprising an automatic drain port located along a base portion of the drain valve.

7. The drain valve according to claim 1 further comprising a mounting portion for attaching the drain valve to the towed vehicle.

8. The drain valve according to claim 7 wherein the mounting portion includes an integrally formed flange capable of mounting directly to the towed vehicle.

9. The drain valve according to claim 7 wherein the mounting portion is configured to attach to a bracket.

10. The drain valve according to claim 1 wherein orientation of the gladhand portion relative to the towed vehicle is adjustable.

11. The drain valve according to claim 10 wherein the body portion is oriented substantially vertical at any orientation of the gladhand portion.

12. The drain valve according to claim 1 wherein air flowing from the air inlet to the sump flows in an upward direction.

13. A drain valve for use on a towed vehicle, comprising:
a gladhand portion; and
a body portion including a sump,
wherein the drain valve is capable of separating an air stream by weight,
wherein the body portion and the gladhand portion are formed as a single, integrated part.

14. The drain valve according to claim 13 further comprising an air inlet and an air outlet, wherein the air inlet is positioned such that an inlet stream of compressed air enters the sump tangentially thereby creating a vortex which separates the inlet stream by weight, and wherein the air outlet is positioned at a top portion of the drain valve and receives a lighter portion of the separated inlet stream for distribution to downstream components.

15. The drain valve according to claim 13 wherein the air inlet is configured as a vertical slot.

16. The drain valve according to claim 13 further comprising an automatic drain port located along a base portion of the drain valve.

17. The drain valve according to claim 13 further comprising a mounting portion for attaching the drain valve to the towed vehicle.

18. The drain valve according to claim 17 wherein the mounting portion includes an integrally formed flange capable of mounting directly to the towed vehicle.

19. The drain valve according to claim 17 wherein the mounting portion is configured to attach to a bracket.

20. The drain valve according to claim 13 wherein orientation of the gladhand portion to the towed vehicle is adjustable.

21. The drain valve according to claim 13 wherein air flowing from the air inlet to the sump flows in an upward direction.

22. A device for connecting the pneumatic lines of a towed vehicle to a pressurized air source, the device comprising:
a gladhand portion having an air passage for transmitting pressurized air from the pressurized air source;
a body portion, the body portion including a sump in fluid communication with the air passage, wherein the body portion is capable of separating liquid from the pressurized air; and
an attachment means for attaching the gladhand portion adjacent the body portion.

23. The device of claim 22 wherein the attachment means includes an integrally formed intermediate portion.

24. The device of claim 22 wherein the attachment means includes a fitting.

25. The device of claim 22 wherein the air passage is angled upward.

26. The device of claim 22 further comprising an automatic drain port located along a base portion of the device.

27. A combination gladhand connector and drain valve, the combination comprising:
a mounting portion for attaching the combination to a towed vehicle;
a gladhand portion;
a drain valve body portion formed as a single, integrated part with the gladhand portion, the drain valve body portion having a sump disposed therein,
wherein the drain valve body portion includes an air inlet and an air outlet, wherein said air inlet is positioned such that an inlet stream of compressed air enters the sump tangentially thereby creating a vortex which reduces contaminants in the inlet stream by weight, and wherein said air outlet is positioned at a top portion of said drain valve body portion and receives a contaminant reduced portion of the inlet stream for distribution to downstream components; and
an automatic drain port located along a base portion of said drain valve body portion.

28. The drain valve according to claim 27 wherein the contaminants include at least one of: liquids and particulates.

29. A method of separating a pressurized air stream by weight, the method comprising the steps of:
connecting a gladhand connector that is in fluid communication with a pressurized air source to a gladhand portion of a drain valve;
feeding a pressurized air stream into the drain valve such that the pressurized air stream forms a vortex within a sump in the drain valve to separate the pressurized air stream into an outlet air stream and a drain stream;
passing the outlet stream through a drain valve outlet and to one or more downstream components;
collecting the drain stream at a bottom portion of the sump; and
automatically draining the drain stream from the sump through a drain port.

30. The method according to claim 28 wherein the step of automatically draining the drain stream further comprises automatically opening the drain port when said sump experiences a relatively low pressure and automatically closing the drain port when said sump experiences a relatively high pressure.

31. The method according to claim 28 wherein the gladhand portion is integral with the drain valve.
